(19) United States
(12) Patent Application Publication
(10) Pub. No.: US 2012/0316907 A1
(43) Pub. Date: Dec. 13, 2012

(54) SYSTEM AND METHOD FOR MANAGING AGENT CONTACT ASSIGNMENTS NEAR END OF AGENT WORK SHIFT

(75) Inventor: Krishna Nimmagadda, Maharastra (IN)

(73) Assignee: AVAYA, INC., Basking Ridge, NJ (US)

(21) Appl. No.: 13/155,054

(22) Filed: Jun. 7, 2011

(51) Int. Cl. G06Q 10/00

(52) U.S. Cl. 705/7.14; 705/7.13

(57) ABSTRACT

Provided herein is a system and method to assign new work to one of a plurality of workers, near an end of a work shift of at least one worker. The method may include: receiving, from a customer, a request for new work; determining a remaining time in a work shift for one or more of the plurality of workers; assigning a worker priority for one or more of the plurality of workers by use of a predetermined criteria; demoting the worker priority of workers near the end of a work shift; and assigning a worker to the customer by use of worker priority, in order to assign the new work.

### BACKGROUND

1. Field of the Invention

Embodiments of the present invention generally relate to systems and methods for managing agent assignments in contact centers, and, in particular, to an improved system and method for managing the assignment of a new contact to an agent when that agent is near the end of his or her work shift.

2. Description of Related Art

Call centers are commonly used by service providers or manufacturers (collectively, “vendors”) to provide customer support. Customers requesting customer support may contact the call center by telephone. As additional methods of communication between agent and customer have been developed such as, but not limited to, e-mail, instant messaging, web chat, and so forth, call centers have evolved into contact centers in order to handle communication by a variety of methods, i.e., beyond telephone calls. An instance of a customer contacting a contact by any of these methods will be referred to herein as a customer contact. In contact centers, quickly finding and assigning a well-qualified service agent to service and fulfill a customer's need is important in providing improved customer satisfaction.

Calling centers are staffed by customer service agents (or simply “agents”) who work a fixed time shift each work day. The start and stop shift times of at least some individual agents may be staggered in order to improve overall calling center continuity at shift change times. When an individual agent is assigned to handle a customer contact, the agent is expected to handle the contact until completion even if doing so would extend beyond the agent's scheduled shift end, except under limited circumstances such as lack of resources or lack of authority.

Extending an agent's work time beyond the scheduled shift end is undesirable at least because the employer may incur additional expenses for overtime pay. In addition, agents at the end of their work shifts are likely to be working at reduced levels of efficiency or performance. Furthermore, the agent may be unhappy about working beyond the scheduled shift end, possibly resulting in rushed service to the customer, a less than helpful attitude toward the customer, and possibly poor morale. Agents may also refuse to handle new customer contacts near the end of their work shifts, thereby reducing productivity during their work shift.

Therefore, a need exists to provide improved management and thus assignment of new work to agents near the end of a work shift, in order to reduce overtime costs, to provide improved agent morale, and ultimately to provide improved customer satisfaction.

### SUMMARY

Embodiments of the present invention generally relate to a system and method for the assignment of new work to one of a group of customer service agents, near the end of a work shift for at least one customer service agent, and in particular to an improved system and method for managing the assignment of a new contact to an agent when that agent is closed to the end of his or her work shift.

In one embodiment of the present invention, a method to assign new work to one of a plurality of workers, near the end of a work shift of at least one worker, includes: receiving, from a customer, a request for new work; determining a remaining time in a work shift for one or more of the plurality of workers; assigning a worker priority for one or more of the plurality of workers by use of a predetermined criteria; demoting the worker priority of workers near the end of a work shift; and assigning the new work to a worker by use of worker priority.

In some embodiments of the present invention, the method further includes: identifying qualified workers to handle the request for new work, wherein the remaining time in a work shift is determined from among the qualified workers.

In some embodiments of the present invention, the method further includes: determining an expected handling time for the new work, wherein demoting the worker priority occurs for workers within the expected handling time of the end of a work shift.

In some embodiments of the present invention, the predetermined criteria used to assign the worker priority include a factor that indicates an ability of the worker to provide the new work.

In some embodiments of the present invention, the method further includes: modifying the expected handling time based upon a factor that indicates an ability of the worker to provide the new work.

In some embodiments of the present invention, demoting the worker priority occurs within a configurable amount of time before the end of a work shift.

In some embodiments of the present invention, demoting the worker priority occurs within the expected handling time before the end of a work shift.

In some embodiments of the present invention, demoting the worker priority is by an amount of demotion that is dependent upon a temporal proximity to the end of a work shift.

In an embodiment of the present invention, a system to assign new work to one of a plurality of workers, near the end of a work shift of at least one worker, includes: a communication channel receiver configured to receive a customer request for new work; a determination module configured to determine a remaining time in a work shift for one or more of the plurality of workers; a first assignment module configured to assign a worker priority for one or more of the plurality of workers by use of a predetermined criteria; a demotion module configured to demote the worker priority of workers near the end of a work shift; and a second assignment module configured to assign the new work to a worker by use of worker priority.

In some embodiments of the present invention, the system further includes: an identification module configured to identify qualified workers to handle the request for new work, wherein the remaining time in a work shift is determined from among the qualified workers.

In some embodiments of the present invention, the system further includes: a determination module configured to determine an expected handling time for the new work, wherein the demotion module is configured to demote the worker priority for workers within the expected handling time of the end of a work shift.

In some embodiments of the present invention, the predetermined criteria, used by the first assignment module to assign the worker priority, includes a factor that indicates an ability of the worker to provide the new work.

In some embodiments of the present invention, the system further includes: a calculation module configured to modify the expected handling time based upon a factor that indicates an ability of the worker to provide the new work.

In some embodiments of the present invention, the demotion module is configured to demote the worker priority within a configurable amount of time before the end of a work shift.

In some embodiments of the present invention, the demotion module is configured to demote the worker priority within the expected handling time before the end of a work shift.

In some embodiments of the present invention, the demotion module demotes the worker priority by an amount of demotion that is dependent upon a temporal proximity to the end of a work shift.

In an embodiment of the present invention, there is provided a system, comprising a computer server, the computer server comprising a tangible computer readable medium comprising program instructions, wherein the program instructions are computer-executable to implement: receiving, from a customer, a request for new work; determining a remaining time in a work shift for one or more of the plurality of workers; assigning a worker priority for one or more of the plurality of workers by use of a predetermined criteria; demoting the worker priority of workers near the end of a work shift; and assigning the new work to a worker by use of worker priority.

In some embodiments of the present invention, the program instructions are computer-executable to further implement: determining an expected handling time for the new work, wherein demoting the worker priority occurs for workers within the expected handling time of the end of a work shift.

In some embodiments of the present invention, the predetermined criteria, used to assign the worker priority, comprises a factor that indicates an ability of the worker to provide the new work.

In some embodiments of the present invention, the demotion module is configured to demote the worker priority within a configurable amount of time before the end of a work shift.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a contact center in accordance with an embodiment of the present invention;

FIG. 2 is a system level block diagram depicting an administrator server in accordance with an embodiment of the present invention;

FIG. 3 is a method for assigning an incoming customer contact to a service agent; and

FIG. 4 is a process for assigning an incoming customer contact to a service agent, according to an embodiment of the present invention.

### DETAILED DESCRIPTION

Embodiments of the present invention generally relate to a system and method for the assignment of new work to one of a group of customer service agents, near the end of a work shift of at least one customer service agent. More specifically, embodiments of the present invention relate to a system and method for managing the assignment of a new contact to an agent when that agent is near the end of his or her work shift.

Although the embodiments below are described in the context of a customer contact center, it should be understood that the system and methods described herein are applicable to workers in substantially any work situation in which individual work assignments are assigned to an individual worker in a work force, other members of the work force are qualified to have handled the work assignment, and the assigned worker is expected to handle the work assignment until completion.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein in connection with embodiments of the present invention, the term “contact” (as in “customer contact”) refers to a communication from a customer or potential customer, in which a request is presented to a contact center. The request can be by way of any communication medium such as, but not limited to, a telephone call, e-mail, instant message, web chat, and the like.

As used herein in connection with embodiments of the present invention, the term “customer” denotes a party external to the contact center irrespective of whether or not that party is a “customer” in the sense of having a commercial relationship with the contact center or with a business represented by the contact center. “Customer” is thus shorthand, as used in contact center terminology, for the other party to a contact or a communications session.

The terms “switch,” “server,” “contact center server,” or “contact center computer server” as used herein should be understood to include a Private Branch Exchange (“PBX”), an ACD, an enterprise switch, or other type of telecommunications system switch or server, as well as other types of processor-based communication control devices such as, but not limited to, media servers, computers, adjuncts, and the like.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting an electrical signal.

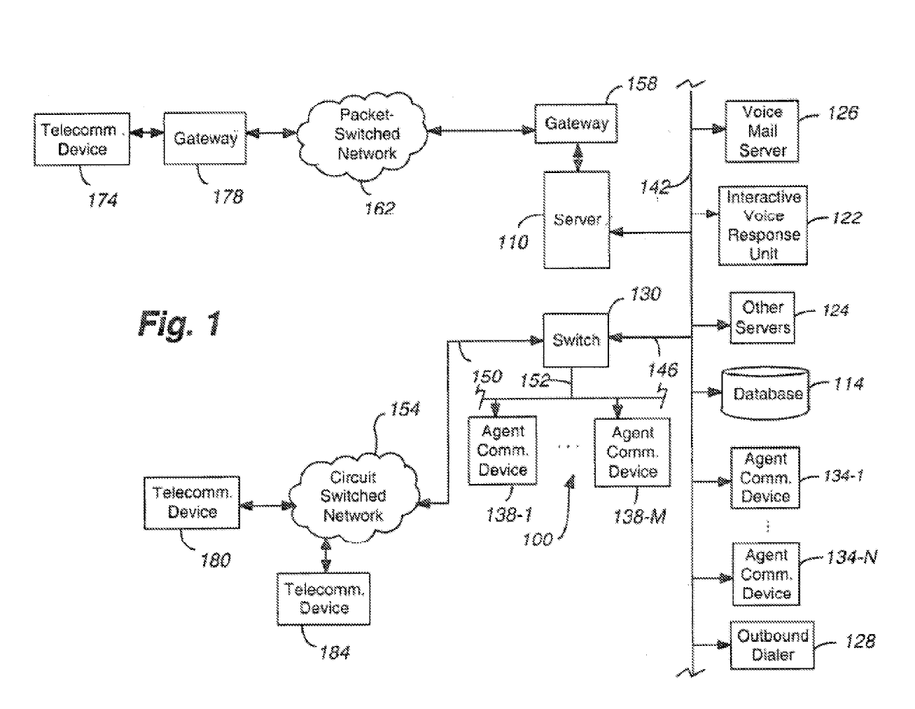

Referring now to FIG. 1, which is a block diagram depicting a contact center in accordance with an embodiment of the present invention, there is provided a contact center 100. The contact center generally comprises a central server 110, a set of data stores or databases 114 containing contact or customer related information and other information that can enhance the value and efficiency of the contact, and a plurality of servers, for example, a voice mail server 126, an Interactive Voice Response unit or “IVR” 122, and other servers 124, an outbound dialer 128, a switch 130, a plurality of working agents operating packet-switched (first) telecommunication devices 134-1 to N (such as, but not limited to, computer work stations or personal computers), and/or circuit-switched (second) telecommunication devices 138-1 to M, all interconnected by a local area network LAN (or wide area network WAN) 142. The servers can be connected via optional communication lines 146 to the switch 130.

As will be appreciated, the other servers 124 can also include a scanner (which is normally not connected to the switch 130 or Web server), VoIP software, video call software, voice messaging software, an IP voice server, a fax server, a web server, an instant messaging server, and an email server) and the like. The switch 130 is connected via a plurality of trunks 150 to the Public Switch Telecommunication Network or PSTN 154 and via link(s) 152 to the second telecommunication devices 138-1 to M. A gateway 158 is positioned between the server 110 and the packet-switched network 162 to process communications passing between the server 110 and the network 162.

The gateway 158 may comprise Avaya Inc.'s, G250™, G350™, G430™, G450™, G650™, G700™, and IG550™ Media Gateways and may be implemented as hardware such as, but not limited to, via an adjunct processor (as shown) or as a chip in the server.

The first telecommunication devices 134-1, . . . 134-N are packet-switched device, and may include, for example, IP hardphones, such as the Avaya Inc.'s, 1600™, 4600™, and 5600™ Series IP Phones™; IP softphones, such as Avaya Inc.'s, IP Softphone™; Personal Digital Assistants or PDAs; Personal Computers or PCs, laptops; packet-based H.320 video phones and/or conferencing units; packet-based voice messaging and response units; and packet-based traditional computer telephony adjuncts.

The second telecommunication devices 138-1, . . . 138-M are circuit-switched. Each of the telecommunication devices 138-1, . . . 138-M corresponds to one of a set of internal extensions, for example, Ext1, . . . ExtM, respectively. These extensions are referred to herein as “internal” in that they are extensions within the premises that are directly serviced by the switch. More particularly, these extensions correspond to conventional telecommunication device endpoints serviced by the switch/server, and the switch/server can direct incoming calls to and receive outgoing calls from these extensions in a conventional manner.

The second telecommunication devices can include, for example, wired and wireless telephones, PDAs, H.320 video phones and conferencing units, voice messaging and response units, and traditional computer telephony adjuncts. Exemplary digital telecommunication devices include Avaya Inc.'s 2400™, 5400™, and 9600™ Series phones.

It should be noted that embodiments of the present invention do not require any particular type of information transport medium between the switch or server and the first and second telecommunication devices, i.e., embodiments of the present invention may be implemented with any desired type of transport medium as well as combinations of different types of transport media.

The packet-switched network 162 of FIG. 1 may comprise any data and/or distributed processing network such as, but not limited to, the Internet. The network 162 typically includes proxies (not shown), registrars (not shown), and routers (not shown) for managing packet flows. The packet-switched network 162 is in (wireless or wired) communication with an external first telecommunication device 174 via a gateway 178, and the circuit-switched network 154 with an external (wired) second telecommunication device 180 and (wireless) third (customer) telecommunication device 184. These telecommunication devices are referred to as “external” in that they are not directly supported as telecommunication device endpoints by the switch or server. The telecommunication devices 174 and 180 are an example of devices more generally referred to herein as “external endpoints.”

In one configuration, the server 110, network 162, and first telecommunication devices 134 are Session Initiation Protocol or SIP compatible and can include interfaces for various other protocols such as, but not limited to, the Lightweight Directory Access Protocol or LDAP, H.248, H.323, Simple Mail Transfer Protocol or SMTP, IMAP4, ISDN, E1/T1, and analog line or trunk.

It should be emphasized the configuration of the switch, server, user telecommunication devices, and other elements, as shown in FIG. 1, is for purposes of illustration only and should not be construed as limiting embodiments of the present invention to any particular arrangement of elements.

As will be appreciated, the central server 110 is notified via LAN 142 of an incoming contact by the telecommunications component (e.g., switch 130, fax server, email server, web server, and/or other server) receiving the incoming contact. The incoming contact is held by the receiving telecommunications component until the server 110 forwards instructions to the component to route, and then forward the contact to a specific contact center resource such as, but not limited to, the IVR unit 122, the voice mail server 126, the instant messaging server, and/or first or second telecommunication device 134, 138 associated with a selected agent. The server 110 distributes and connects these contacts to telecommunication devices of available agents, based on the predetermined criteria noted above.

When the central server 110 forwards a voice contact to an agent, the central server 110 also forwards customer-related information from databases 114 to the agent's computer work station for viewing (such as by a pop-up display) to permit the agent to better serve the customer. The agents process the contacts sent to them by the central server 110. This embodiment is particularly suited for a Customer Relationship Management (CRM) environment in which customers are permitted to use any media to contact a business. In the CRM environment, both real-time and non-real-time contacts may be handled and distributed with equal efficiency and effectiveness. The server 110 may use a work assignment algorithm that, for example, does not use a queue. In any event, the contact may have associated or “known” contact information. This contact information may include, for example, how long the contact has been waiting, the contact's priority, the contact's media channel, the contact's business value, etc. The contact may be handled based on such known contact information.

The server and/or switch can be a software-controlled system including a processing unit (CPU), microprocessor, or other type of digital data processor executing software or an Application-Specific Integrated Circuit (ASIC) as well as various portions or combinations of such elements. The memory may comprise random access memory (RAM), a read-only memory (ROM), or combinations of these and other types of electronic memory devices. Embodiments of the present invention may be implemented as software, hardware (such as, but not limited to, a logic circuit), or a combination thereof.

The contact center 100, in one configuration, includes an automated instant messaging server as another server 124. In such an embodiment, when a customer initiates contact with the contact center 100 using instant messaging, a new instant messaging thread is initiated by the customer. As will be appreciated, instant messages are stand-alone messages, and threading (or associating instant messages with data structures associated with an instant messaging session between a customer and an agent) occurs at the application level. The association is typically effected by pairing an electronic address (e.g., IP address, Media Access Control (MAC) address, telephone number, mobile-device identifier, and the like) of the customer's communication device with an electronic address (e.g., IP address, MAC address, telephone number, mobile-device identifier, and the like) of the agent's communication device in a manner similar to that used for a voice call.

The instant messaging server can be configured to send an automated response, such as “Please wait while I connect you with an agent” and/or to send the instant message to an automated interactive response unit for data collection. The instant messaging server subsequently notifies the server 110 of the existence of a new instant messaging contact, and the server 110 decides whether a suitable (human) agent is available. If an agent is available, the server 110 instructs the instant messaging server to redirect the instant messaging conversation to that available agent's communication device 134-1 . . . N. The server 110 routes, substantially in real-time, subsequent instant messages from the agent's communication device to the customer's communication device and from the customer's communication device to the agent's communication device.

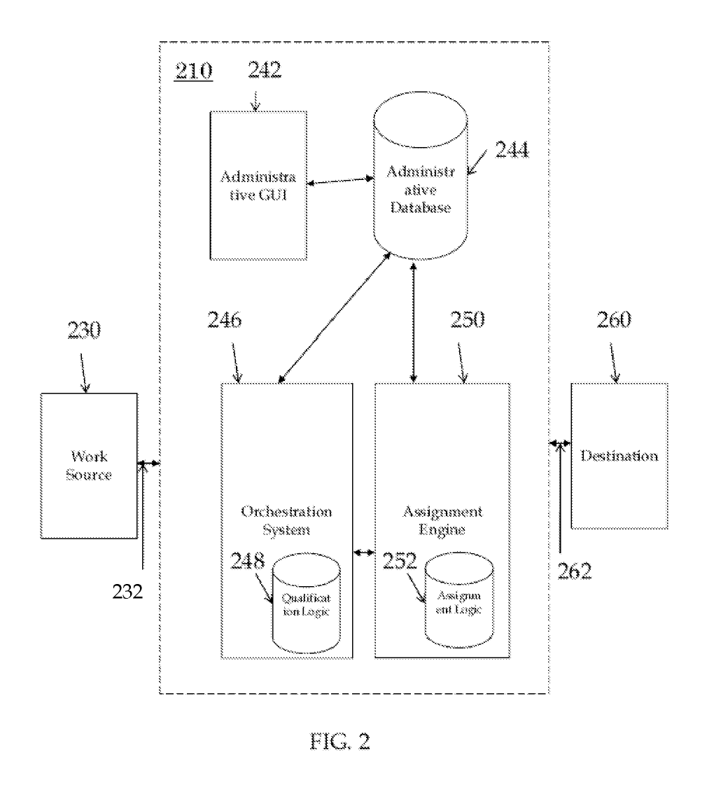

Referring to FIG. 2, which depicts a block diagram of a server 210 in accordance with an embodiment of the present invention, there is provided a server 210 in communication with a work source 230, which may comprise customer or any other entity capable of originating a transmission of work or a contact. The server 210 may be configured in communication with the work source 230 generally via a work source communication means 232, which may comprise any means of communicating data, for example, one or more trunks, phone lines, wireless connections, Bluetooth connections, digital connections, analog connection, combinations thereof, and the like.

In some embodiments of the present invention, the server 210 may also be in communication with a destination 260, which may comprise an agent or any entity capable of receiving a transmission of work or a contact. The server 210 may be configured in communication with the destination 260 generally via an agent communication means 262, which may comprise any means of communicating data, for example, a voice-and-data transmission line such as LAN and/ or a circuit switched voice line, wireless connections, Bluetooth connections, digital connections, analog connections, combinations thereof, and the like. The server 210 may comprise any type of computer server, for example, a Basic Call Management System (“BCMS”) and a Call Management System (“CMS”) capable of segmenting work.

The server 210 can be any architecture for directing contacts to one or more telecommunication devices. Illustratively, the server may be a modified in the form of Avaya Inc.'s Definity™ Private-Branch Exchange (PBX)-based ACD system; MultiVantage™ PBX, CRM Central 2000 Server™, Communication Manager™, Business Advocate™, Call Center™, Contact Center Express™, Interaction Center™, and/or S8300™, S8400™, S8500™, and S8700™ servers; or Nortel's Business Communications Manager Intelligent Contact Center™, Contact Center—Express™, Contact Center Manager Server™, Contact Center Portfolio™, and Messaging 100/150 Basic Contact Center™.

In many embodiments, the server 210 may be a stored-program-controlled system that conventionally includes, for example, interfaces to external communication links, a communications switching fabric, service circuits (e.g., tone generators, announcement circuits, and the like.), memory for storing control programs and data, and a processor (i.e., a computer) for executing the stored control programs to control the interfaces and the fabric and to provide automatic contact-distribution functionality. The server 210 generally may include a network interface card (not shown) to provide services to the serviced telecommunication devices.

The server 210 may be configured for segmenting work in the contact center and may comprise an administrative database 244 configured to store at least a common skill option and a service skill option; an administrative graphical user interface (“GUI”) 242 for accessing at least the administrative database 244 and configuring the common skill option and the service skill option; an orchestration system 246 configured to receive a contact from a work source 230 and orchestrate the contact according to a qualification logic stored in a qualification logic database 248; and an assignment engine 250 configured to receive the contact, the common skill option, and the service skill option, and segment the contact according to an assignment logic stored in an assignment logic database 252. In accordance with some embodiments of the present invention, the qualification logic stored in the qualification logic database 248 and the assignment logic stored in the assignment logic database 252 may comprise any logical set of steps or sequences configured to process data at the call center in accordance with any embodiment of the present invention.

The server and/or switch can be a software-controlled system including a processing unit (CPU), microprocessor, or other type of digital data processor executing software or an Application-Specific Integrated Circuit (ASIC) as well as various portions or combinations of such elements.

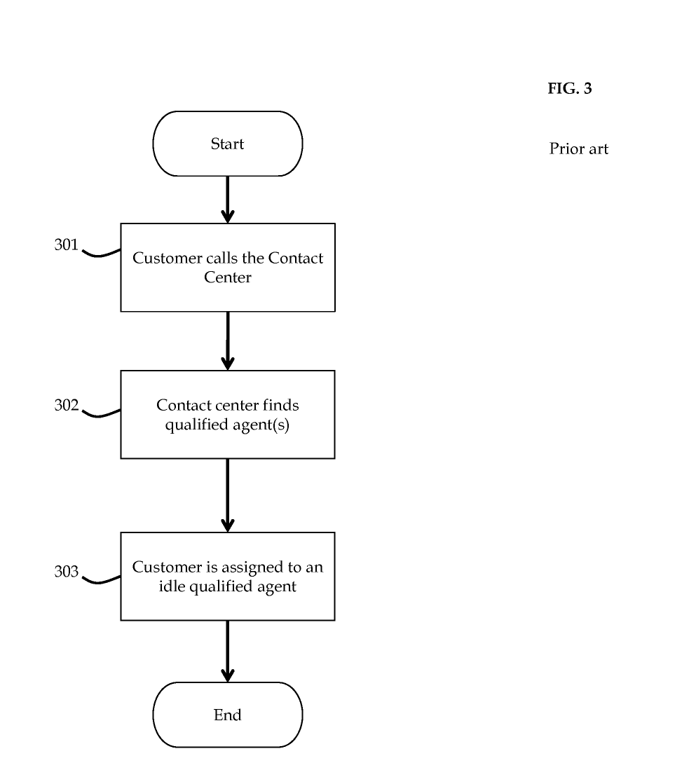

FIG. 3 illustrates at a high level of abstraction a method for assigning an incoming customer contact to a service agent. At step 301, an incoming customer contact is received by the contact center. At step 302, the contact center finds a qualified agent to assign the customer contact to, based on factors such as the product or service involved, the nature of the problem reported by the customer, the identity of the customer (e.g., a premium service subscriber), severity, customer-identified priority, support language, etc. These characteristics may be matched against the skills of available agents to find a set of qualified agents.

At step 303, the contact center assigns the customer contact to a qualified agent. Ordinarily, the assigned qualified agent is idle when the assignment is made, unless a queue of pending assignments is maintained for or by the agent.

These steps concentrate on customer satisfaction and are generally sufficient. However, where agents may be at the end of a shift, the steps of FIG. 3 may not adequately address keeping up agent morale, concentration and energy. In particular, the timing of assigning and the transferring calls to agents can affect an agent's morale, energy levels, and thus how an agent responds to customers on calls.

For instance, contact centers have specific shifts (i.e., start and stop times) for service agents. Having to accept calls or contacts in the final moments of an agent's shift is a concern for agents because it may take a long time to address the customer issue, thereby causing the call to extend past the agent's scheduled shift end time. Agents ordinarily are not happy when this happens because the extension is unplanned, disruptive, and may not be compensated for. The extension may represent a potential overtime expense for the employer as well. To avoid such overtime calls, agents may be reluctant to take calls near the end of their shifts, causing a loss of productivity during their shift ends and a detriment to contact center metrics of operational efficiency.

Embodiments of the present invention generally relate to a system and method for the assignment of new work to one of a group of customer service agent near the end of a work shift for at least one customer service agent.

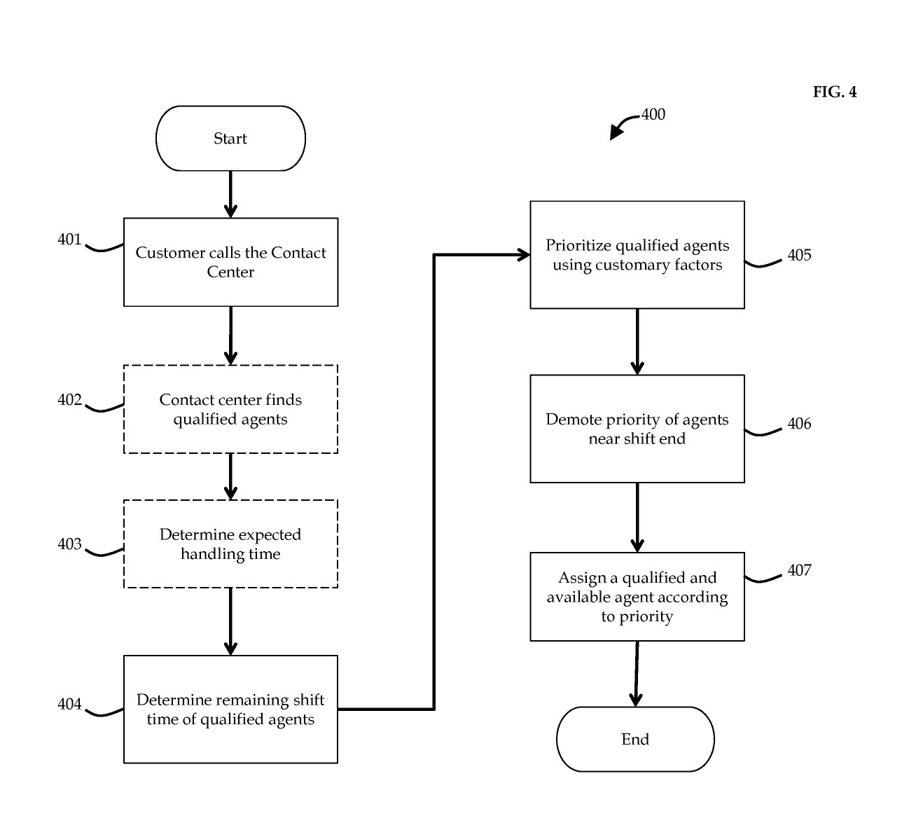

FIG. 4 illustrates, at a high level of abstraction, a process 400 for assigning an incoming customer contact to a service agent, according to an embodiment of the present invention. Optional steps of process 400 are illustrated using dashed lines. At step 401, an incoming customer contact is received by the contact center, e.g., as described with reference to FIG. 1. At step 402, the contact center may find a qualified agent to which to assign the customer contact, based on factors such as, but not limited to, the product or service involved, the nature of the problem reported by the customer, the identity of the customer (e.g., a premium service subscriber), severity, customer-identified priority, support language, etc. These characteristics may be matched against the skills of available agents to find a set of qualified agents. Step 402 may be optional if the agents and the customer contacts are fungible, i.e., if it is deemed that substantially all agents are substantially equally capable of handling substantially all incoming customer contacts.

At optional step 403, an expected handling time is determined. Handling time refers to the amount of time it would be expected to take for the service agent to handle the sort of problem for which the customer contacted the contact center. The expected handling time may be based on a historical record of actual handling times for service contacts sharing one or more characteristics with the present customer contact. For instance, the shared characteristic(s) may include one or more of contact type, identity of the end-customer, repeat contact status, nature of the problem, criticality of the problem, etc. The “expected” handling time may refer to an average, a median, a percentile (e.g., 75th percentile, 90th percentile, etc.), other statistical measures (e.g., mean +3 sigma, etc), or so forth. The expected handling time may vary from one customer contact to another.

At step 404, the remaining shift time of qualified agents is determined. The remaining shift time would be the amount of time each qualified agent will be at work before their current work shift ends for the day. Because work shifts of current agents may be staggered relative to other agents, the qualified agents generally may have a range of remaining shift time.

Next, at step 405, the qualified agents may be prioritized using the known factors customarily used. Such factors may tend to estimate the likely ability, effectiveness and efficiency of a service agent to handle a customer contact. For instance, the factors may tend to correlate one or more characteristics of the customer contact with the skills, training, etc. of the service agent. Or, in another example, the factors may include whether the agent has had any prior dealings with the present end-customer, the end-customer's employer, the contact type, repeat contact status, nature of the problem, criticality of the problem, etc.

Optionally, the degree of match between the characteristics of the customer contact with the skills, training, etc. of the service agent may be used to adjust the expected handling time. For instance, a closer degree of match would tend to indicate a shorter expected handling time for that agent. A lesser degree of match would tend to indicate a longer expected handling time for that agent. Notably, in step 405 the known factors customarily used do not include consideration of the time remaining in the service agent's work shift.

Next, at step 406, the priority is demoted for service agents who are sufficiently close in time to the end of their work shift. The amount of demotion will be sufficient to cause substantially all service agents who are sufficiently close in time to the end of their work shift to have lower priority than substantially all service agents who are not sufficiently close in time to the end of their work shift.

In one embodiment of the present invention, sufficiently close in time may be determined by the expected handling time determined in optional step 403. For instance, if a service agent is less than the “expected handling time” from the end of their shift for a customer call, then their priority is demoted for the customer call.

In another embodiment of the present invention, sufficiently close in time as used in step 406, particularly if optional step 403 was not performed, may be determined as a flat amount (e.g., two minutes), or as an average of the handling time for all customer contacts regardless of the characteristics of the customer contact and regardless of a degree of match between the customer contact and the service agent's qualifications. Other methods of determining intervals “sufficiently close in time” may be used, and embodiments of the present invention are not limited in this regard. The amount of time may be configurable by the operator of the calling center.

In another embodiment of the present invention, the amount of demotion may depend upon a temporal proximity (i.e., how close in time) the service agent is to the end of their work shift. For instance, workers who are closer to the end of their work shift may receive a larger priority demotion than workers not as close to the end of their work shift.

Next, process 400 transitions to step 407, during which the customer contact is assigned to a qualified and available agent based on the agent's priority after any demotion from step 406. The amount of demotion applied in step 406 was sufficient to cause substantially all service agents who are sufficiently close in time to the end of their work shift to have lower priority than substantially all service agents who are not sufficiently close in time to the end of their work shift. Optionally, service agents may be sorted by priority within these two groups. Therefore, of all qualified and available service agents, those service agents who are not close to the end of their work shift will be selected before those who are close to the end of their work shift. However, if the only qualified and available service agents are those who are close to the end of their work shift, the customer contact will be assigned to those agents so the level of customer service is highly maintained.

Embodiments of the present invention include a system having one or more processing units coupled to one or more memories. The one or more memories may be configured to store software that, when executed by the one or more processing unit, allows for the assignment of new work to one of a group of customer service agent near the end of a work shift of at least one customer service agent, such that a likelihood or amount of overtime work is reduced.

### EXAMPLE SCENARIO

Embodiments of the present invention may be illustrated by use of an example scenario described below. The example scenario is not limiting, and other example scenarios may be possible that are in accordance with embodiments of the present invention.

Assume that a first service agent (“A1”) logs in at 9:00 PM. A second service agent (“A2”) and a third service agent (“A3”) each log in at 10:00 PM. Each shift is 9 hours in duration, so A1's shift ends at 6:00 AM, and the shifts of A2 and A3 end at 7:00 AM. The contact center is configured such that “sufficiently close in time,” as used and described with respect to step 406 of process 400 (FIG. 4), is 60 seconds. Assume that A1, A2 and A3 are equally qualified for the calls in this example scenario.

During most of the time of the shifts, calls are assigned to the agents according to known assignment processes described earlier that tend to correlate one or more characteristics of the customer contact with characteristics of the service agent, and so forth. During most of the time of the shifts, it is not necessary to consider the end of the shifts. However, at 5:59 am, that time being “sufficiently close in time” to the end of the shift of A1, the priority assigned to A1 for new calls is demoted to below the priority of A2 and A3.

Next, assume that a customer contact arrives at 5:59 AM. If both A1 and A3 are available when the customer contact arrives, then because of A1's demoted priority the contact center will assign the call to A3 even if A1 may have been available for more time as compared to A3. If another call arrives after A3 accepts the call and if A2 is available, then A2 will be assigned the call rather than A1, even if A1 has been idle and available for more time than A2. In this situation, A1 can log out at 6:00 AM without any extension in the shift hours, thus resulting in employee satisfaction and no overtime.

However, assume instead that at 5:59 AM, A2 is handling a first call but that A1 and A3 are available. Assume that a second call arrives at 5:59 AM—the contact center will assign the second call to A3. Further assume that a third call arrives some time between 5:59 AM and 6:00 AM, and that A2 and A3 are still busy handling the first and second calls, respectively. Then A1 is the only available agent, and the third call is assigned to A1 despite A1's demoted priority.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A method to assign new work to one of a plurality of workers, near the end of a work shift of at least one worker, comprising:
receiving, from a customer, a request for new work;
determining a remaining time in a work shift for one or more of the plurality of workers;
assigning a worker priority for one or more of the plurality of workers by use of a predetermined criteria;
demoting the worker priority of workers near an end of a work shift; and
assigning the new work to a worker by use of worker priority.

2. The method of claim 1, further comprising: identifying qualified workers to handle the request for new work, wherein the remaining time in a work shift is determined from among the qualified workers.

3. The method of claim 1, further comprising: determining an expected handling time for the new work, wherein demoting the worker priority occurs for workers within the expected handling time of the end of a work shift.

4. The method of claim 1, wherein the predetermined criteria used to assign the worker priority comprises a factor that indicates an ability of the worker to provide the new work.

5. The method of claim 3, further comprising: modifying the expected handling time based upon a factor that indicates an ability of the worker to provide the new work.

6. The method of claim 1, wherein demoting the worker priority occurs within a configurable amount of time before the end of a work shift.

7. The method of claim 3, wherein demoting the worker priority occurs within the expected handling time before the end of a work shift.

8. The method of claim 1, wherein demoting the worker priority is by an amount of demotion that is dependent upon a temporal proximity to the end of a work shift.

9. A system to assign new work to one of a plurality of workers, near the end of a work shift of at least one worker, comprising:
a communication channel receiver configured to receive a customer request for new work;
a determination module configured to determine a remaining time in a work shift for one or more of the plurality of workers;
a first assignment module configured to assign a worker priority for one or more of the plurality of workers by use of a predetermined criteria;
a demotion module configured to demote the worker priority of workers near an end of a work shift; and
a second assignment module configured to assign the new work to a worker by use of worker priority.

10. The system of claim 9, further comprising: an identification module configured to identify qualified workers to handle the request for new work, wherein the remaining time in a work shift is determined from among the qualified workers.

11. The system of claim 9, further comprising: a determination module configured to determine an expected handling time for the new work, wherein the demotion module is configured to demote the worker priority for workers within the expected handling time of the end of a work shift.

12. The system of claim 9, wherein the predetermined criteria used by the first assignment module to assign the worker priority comprises a factor that indicates an ability of the worker to provide the new work.

13. The system of claim 11, further comprising: a calculation module configured to modify the expected handling time based upon a factor that indicates an ability of the worker to provide the new work.

14. The system of claim 9, wherein the demotion module is configured to demote the worker priority within a configurable amount of time before the end of a work shift.

15. The system of claim 11, wherein the demotion module is configured to demote the worker priority within the expected handling time before the end of a work shift.

16. The system of claim 9, wherein the demotion module demotes the worker priority by an amount of demotion that is dependent upon a temporal proximity to the end of a work shift.

17. A system, comprising a computer server, the computer server comprising a tangible computer readable medium comprising program instructions, wherein the program instructions are computer-executable to implement:
receiving, from a customer, a request for new work;
determining a remaining time in a work shift for one or more of the plurality of workers;
assigning a worker priority for one or more of the plurality of workers by use of a predetermined criteria;
demoting the worker priority of workers near an end of a work shift; and
assigning the new work to a worker by use of worker priority.

18. The system of claim 17, wherein the program instructions are computer-executable to further implement:
determining an expected handling time for the new work, wherein demoting the worker priority occurs for workers within the expected handling time of the end of a work shift.

19. The system of claim 17, wherein the predetermined criteria used to assign the worker priority comprises a factor that indicates an ability of the worker to provide the new work.

20. The system of claim 17, wherein the demotion module is configured to demote the worker priority within a configurable amount of time before the end of a work shift.
